(19) United States
(12) Patent Application Publication
(10) Pub. No.: US 2026/0261473 A1
(43) Pub. Date: Sep. 3, 2026

(54) EFFICIENT FAIL OVER TO BACKUP LINK

(71) Applicant: Adeia Media Holdings LLC, San Jose, CA (US)

(72) Inventor: Bernard Breton, Gatineau (CA)

(21) Appl. No.: 19/454,708

(22) Filed: Jan. 21, 2026

Related U.S. Application Data
(63) Continuation of application No. 17/449,495, filed on Sep. 30, 2021, now Pat. No. 12,676,785.

(51) Int. Cl. H04L 41/0663; H04L 41/0604; H04L 41/0668; H04L 43/0823

(52) U.S. Cl. CPC H04L 41/0663; H04L 41/0627; H04L 41/0668; H04L 43/0847

(57) ABSTRACT

A system and method for efficient fast failover of a primary link to a secondary link comprising monitoring an amount of user packets on said primary link and sending synthetic packets on said secondary link at a predetermined rate based on said amount of user packets wherein said predetermined rate is changed as a function of change in said amount of user packets.

### BACKGROUND

In telecommunication networks, as per FIG. 1, there is often a need to have a backup link 108 in case a primary link 106 fails. The primary link 106 and backup link 108 connect a networking device 102 to the network 104. The primary link 106 and backup link 108 may be wired or wireless.

In the case of a wireless backup link 108, the networking device 102 must keep the backup link 108 active by sending synthetic packet 112 at regular intervals while the data packets 110 are sent over the primary link 106. Otherwise the connection could be torn down and the fail over from the primary link 106 will take a long time.

The interval between synthetic packets is generally short (e.g. 100 msec), which means it generates a lot of bandwidth on the secondary link. Since the secondary link is generally wireless and pay-by-use, this method of keeping the secondary link active is not efficient and can be costly.

In general, the networks carry packets with different priority. For example, voice and video packets are generally carried with higher priority than data packets. This means the network elements that are traversed by the higher priority packets to reach their destination are treated preferentially to the lower priority packets. Note that there can be more than two priorities of packets carried by a network and preference can also be given based on the applications used to transmit the packets. For example, Transmission control Protocol (TCP) or User datagram protocol (UDP) can be used as protocol to transmit data packets and a higher priority can be assigned to UDP traffic over TCP traffic, since UDP protocol does not have retransmit.

There is a need to keep a backup link 108 active with an efficient protocol.

### BRIEF SUMMARY

In a first embodiment, a method for efficient fast failover of a primary link to a secondary link is disclosed. The method comprises monitoring an amount of user packets on the primary link and sending synthetic packets on the secondary link at a predetermined rate based on the amount of user packets wherein said predetermined rate is changed as a function of change in the amount of user packets.

In another embodiment, the primary link is a fixed link and the secondary link is a wireless link.

In another embodiment, the monitoring said amount of user packets counts only packets of high priority.

In another embodiment, a system for efficient fast failover of a primary link to a secondary link is disclosed. The system comprises a network device monitoring an amount of user packets on the primary link and wherein the network device sending synthetic packets on the secondary link at a predetermined rate based on the amount of user packets wherein the predetermined rate is changed as a function of change in the amount of user packets.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates existing art on handling primary and backup links.

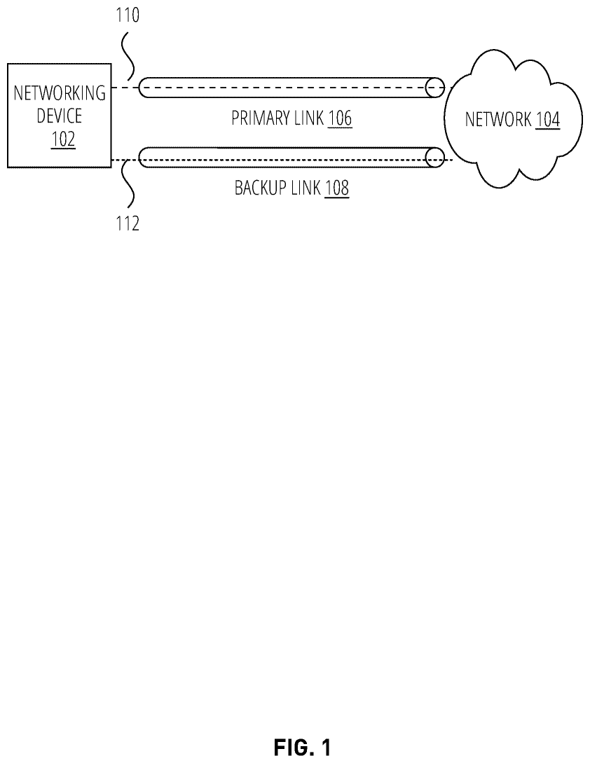

FIG. 2 illustrates an embodiment of efficient fail over.

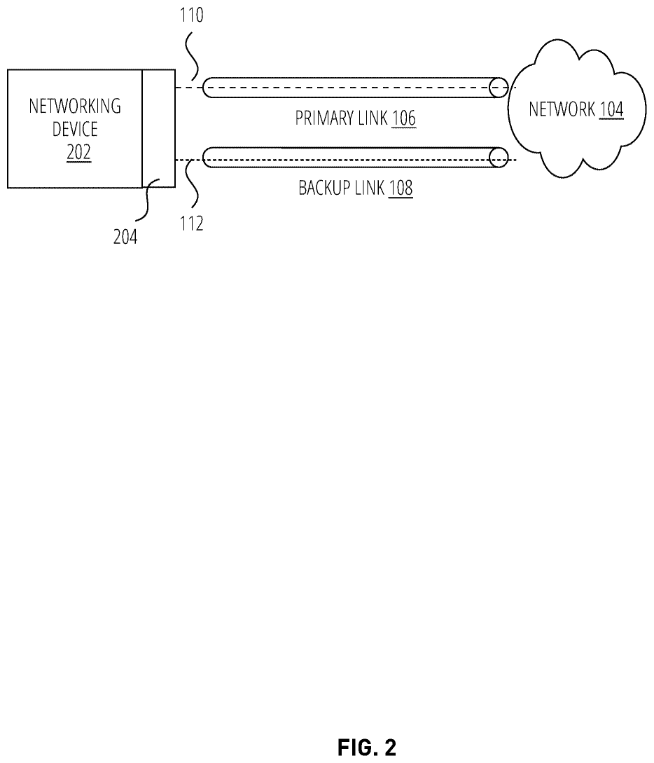

### DETAILED DESCRIPTION

In one embodiment, the networking device 102 comprises a backup link keep alive 204 system. The backup link keep alive 204 monitors the rate of data packets 110 sent on the primary link 106. The backup link keep alive 204 system sends synthetic packet 112 to the backup link 108 at a rate proportional to the amount of data packets 110 on the primary link 106. Thus, when the primary link 106 is lightly utilized, there are less synthetic packet 112 sent on the backup link 108 and when there is a lot of traffic on the primary link 106, more synthetic packet 112 are sent on the backup link 108 to ensure that a failover happens within expected delays.

For example, the networking device 102 sends 1 synthetic packet 112 for every 1000 data packets 110 sent on the primary link 106. Another example, the networking device 102 monitors the rate at which data packets 110 are sent on the primary link 106 and sends the synthetic packet 112 at a rate of 0.1% of the rate of the data packets 110. As the rate of data packets 110 changes, the rate of synthetic packet 112 changes.

In another embodiment, the backup link keep alive 204 system analyses the priority of data packets 110 sent on the primary link 106. The amount of synthetic packet 112 sent to the backup link 108 is proportional to the high priority data packets 110 sent on the primary link 106 instead of all the type of data packets 110. This embodiment allows to further reduce the amount of backup link 108 bandwidth utilized by synthetic packet 112.

For example, the networking device 102 sends 1 synthetic packet 112 for every 1000 high priority data packets 110 sent on the primary link 106. Another example, the networking device 102 monitors the rate at which high priority data packets 110 are sent on the primary link 106 and sends the synthetic packet 112 at a rate of 0.1% of the rate of the data packets 110. As the rate of data packets 110 changes, the rate of synthetic packet 112 changes.

In another embodiment, the backup link keep alive 204 system analyses the type of data packets 110 sent on the primary link 106. The amount of synthetic packet 112 sent to the backup link 108 is proportional to the amount of data packets 110 of voice and video type sent on the primary link 106 instead of all the type of data packets 110. This embodiment allows to further reduce the amount of backup link 108 bandwidth utilized by synthetic packet 112.

The embodiments described above can be used with any networking protocols, such as, but not limited to UDP, TCP that are used on the primary link 106 and backup link 108 to communicate with the network 104.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU). Computers suitable for the execution of a computer program include, by way of example, general or special purpose microprocessors or both, or any other kind of central processing unit. Generally, a central processing unit receives instructions and data from a read-only memory or a random-access memory or both. A computer can also include, or be operatively coupled to receive data from, or transfer data to, or both, one or more mass storage devices for storing data, e.g., optical disks, magnetic, or magneto optical disks. It should be noted that a computer does not require these devices.

1-6. (canceled)

7. A method comprising:
detecting data transmission over a primary communication link between a device and a network;
transmitting keep alive signals from the device over a secondary communication link, wherein the secondary communication link is a wireless backup link for the primary communication link; and
adjusting a transmission rate of the keep alive signals over the secondary communication link, wherein the adjusting comprises:
increasing the transmission rate of the keep alive signals when a usage level of the primary communication link is at a high usage level; and
decreasing the transmission rate of the keep alive signals when the usage level of the primary communication link is lower than the high usage level.

8. The method of claim 7, wherein at the high usage level a failover from the primary communication link to the secondary communication link is faster than is the failover from the primary communication link to the secondary communication link at the usage level lower than the high usage level.

9. The method of claim 7, wherein a rate of increase of the transmission rate of the keep alive signals on the secondary communication link is proportional to the rate of increase of the usage level of the primary communication link.

10. The method of claim 7, wherein a rate of increase of the transmission rate of the keep alive signals on the secondary communication link is proportional to the rate of increase of the usage level by packets carrying voice data or video data over the primary communication link.

11. The method of claim 7, wherein the transmission rate of the keep alive signals on the secondary communication link is a function of the usage level of the primary communication link.

12. The method of claim 7, wherein the adjusting the transmission rate of the keep alive signals over the secondary communication link comprises continuing to adjust the transmission rate of the keep alive signals on the secondary communication link based at least in part on detecting changes in the usage level of the primary communication link.

13. The method of claim 7, wherein the adjusting the transmission rate of the keep alive signals over the secondary communication link is performed by the device.

14. The method of claim 7, wherein the network is a first network, and the secondary communication link is between the device and the first network.

15. The method of claim 7, wherein the primary communication link is a wireless link and the network is a wireless network.

16. The method of claim 7, wherein the keep alive signals comprise synthetic data packets.

17. The method of claim 7, wherein the adjusting the transmission rate of the keep alive signals is performed by the device.
